(19) United States
(12) Patent Application Publication
(10) Pub. No.: US 2006/0266148 A1
(43) Pub. Date: Nov. 30, 2006

(54) Steering shaft

(76) Inventors: Manfred Heintschel, Schwaebisch Gmuend (DE); Walter Kogel, Abtsgmuend (DE); Guenter Dieterle, Lorch (DE)

Correspondence Address: JORDAN AND HAMBURG LLP, 122 EAST 42ND STREET, SUITE 4000, NEW YORK, NY, 10168, US

(21) Appl. No.: 11/361,080

(22) Filed: Feb. 23, 2006

(30) Foreign Application Priority Data
May 27, 2005 (DE) 10 2005 024 280.4

(51) Int. Cl. G05G 11/00

(52) U.S. Cl. 74/485

(57) ABSTRACT

A steering shaft especially for a motor vehicle has a torque-induced operative connection of a steering handling device with a steered wheel with a first shaft and with a second shaft, the shafts being connected torque-induced over a shaft joint with movavable joints. In order to create a steering shaft, the shaft joint of which achieves a large range, over which the deflection angle can be adjusted in all directions, while, at the same time, rotational nonuniformities of the steering shaft are minimized, the shaft joint is fixed at a component, which is attached to the vehicle, so that it can be swiveled approximately about the joint center with a device for the pivotable mounting of the shaft joint.

### BACKGROUND OF THE INVENTION

The invention relates to a steering shaft, especially for a motor vehicle for the torque-induced operative connection of a steering handling device with a steered wheel.

Steering shafts for the torque-induced operative connection of a steering handling device or a steering wheel with a steered wheel with an angled course of parts of the steering shaft are known. The shafts are connected with shaft joints, especially with movable shaft joints, such as universal joints, with one another or also with a steering mechanism or bevel gear transmission in the intermediate shaft so formed. For example the DE 40000994 A or the JP 11043050A describes a steering shaft for the torque-induced operative connection of a steering handling device with a steered wheel, simple cardan joints being employed for connecting the individual components of the steering shaft. Because of their cardan joints, the steering shafts are greatly limited with respect to their deflection angle and, in operation, as is well known, have increasing rotational nonuniformities as the deflection angle increases. This results in torque fluctuations and affects the driving comfort. In addition, when a steering column, equipped with such a steering shaft, is adjusted, different deflection angles result in the shaft joint, which, depending on the magnitude of the deflection angle, favor rotational torque fluctuation and, as a result, cause corresponding torque fluctuations at the steering wheel and, with that, an uncomfortable and imprecise steering sensation.

Due to the requirement in practice of an increasingly larger adjustment range of the steering wheel, these rotational nonuniformities become increasingly larger, thus intensifying the disadvantage described.

### SUMMARY OF THE INVENTION

It is an object of the invention to create a steering shaft, the shaft joint of which permits a larger range, over which the deflection angle can be adjusted in all directions while, at the same time, rotational nonuniformities of the steering shaft are minimized.

Owing to the fact that the shaft joint can be swiveled about its center point with the help of a device for the pivotable mounting or fixing of the shaft joint at a component fixed to the vehicle, a controlled shaft joint is created in the sense of a homokinetic shaft joint, which can be bent over a defined deflection angle in all directions of the steering shaft (x and y directions). Due to the device for the pivotable mounting of the shaft joint at the component fixed to the vehicle, the shaft joint is constantly fixed in its position. By these means, however, the steering shaft can nevertheless be deflected laterally.

Preferably, the shaft joint is constructed as a homokinetic joint, an inner race having grooves for the tangential and axial fixing of balls and the balls, in turn, engaging grooves of an outer race with a spherical outer surface and thus enabling a torque to be transferred from the outer race to the inner race, the races being at an angle to one another. The homokinetic joint enables the rotational nonuniformities of the steering shaft to be minimized. The homokinetic joint may be constructed as a simple or double homokinetic joint.

The device for pivotably mounting the shaft joint may be constructed from a yoke-shaped swivel fork, through which, for example, a shaft of the steering shaft protrudes and the swiveling axis of which extends transversely to the shaft, preferably precisely through the joint center of the shaft joint or the homokinetic joint. The device for pivotably mounting the shaft joint or the swivel fork thus makes possible a bearing position for the shaft joint at a component that is attached to the vehicle. The steering shaft or a shaft of the steering shaft preferably is disposed axially immovably or movable only to a lesser extent with respect to the device for the pivotable mounting of the shaft joint. However, it may be tiltable with respect to the device.

Particularly in the case that the shaft joint is formed as a homokinetic joint with an external race with a spherical outer surface, it is advisable to take the outer surface, which is formed centrosymmetrically about the center of the joint, as a bearing surface for a spherical plain bearing with a thereto accurately fitting spherical inner surface or partially spherical inner surface and thus to form a device for the pivotable mounting of the shaft joint.

The spherical plain bearing may be constructed as a bearing ring with a partially spherical inner surface. The bearing ring enables the steering shaft and its shaft joint therein to swivel within a wide range in all directions.

The device for the pivotable mounting of the shaft joint or of the bearing ring or the swivel fork may be fixed in a simple manner at a side board of a driver cab of the vehicle. The side wall may be also the partition between the engine compartment and the driver cab of the motor vehicle or a bearing block attached to the vehicle.

The device for the pivotable mounting of the shaft joint or of the bearing ring or the swivel fork, may also be fixed in an opening of a side wall, through which the steering shaft is passed, or in an opening in the floor of the driver cab. The broad range of deflection angles and the pivoting range, made possible with the inventive steering shaft, are suitable especially for using the steering shaft in a commercial vehicle, which is constructed as a conventional truck or as vehicle with a tilting cab and, quite generally, for use in vehicles with a steering system that must meet different terrain-specific requirements. The device for the pivotable mounting of the shaft joint may be formed essentially from plastic, especially from a plastic sliding material or from a light metal.

The inventive steering shaft may be integrated in an adjustable steering shaft arrangement, the steering shaft being configured so that its position can be shifted with a steering shaft holding device relative to a bearing block fastened to the vehicle. The device for fixing the position of the steering shaft holding device and/or of the steering shaft may be disposed essentially within the bearing block, since the steering shaft with its device for the pivotable mounting of the shaft joint is constructed compactly. Different versions of devices for fixing the position of the steering shaft holding device, such as an electric, pneumatic, hydraulic or mechanical device for fixing the position of the steering shaft holding device may be disposed in the bearing block, so that the steering shaft can be used in a universal steering system for different types of vehicles and terrain-specific types of vehicle.

The invention is now described in greater detail by means of an example, and the attached drawings.

### BRIEF DESCRIPTION OF THE DRAWINGS

FIG. 1 shows a longitudinal section through a steering shaft with a device for the pivotable mounting of a shaft joint at a component fixed to the vehicle,

FIG. 2 shows a perspective view of the steering shaft of FIG. 1 in an elongated position,

FIG. 3 shows a perspective view of the steering shaft of FIG. 1 in an angled position,

FIG. 4 shows a perspective view of a steering shaft with a device, constructed as a swivel fork, for pivotably mounting a shaft joint at a component attached to the vehicle, and

FIG. 5 shows a perspective view of the steering shaft of FIG. 4 at a side wall of a cab of a motor vehicle.

### DESCRIPTION OF THE PREFERRED EMBODIMENTS

In FIG. 1, a steering shaft 1 for a motor vehicle is shown partly in longitudinal section. The steering shaft 1 brings about the torque-induced connection of a steering handling device with a steering mechanism and with tie rods and wheel steering levers, driven by these, for adjusting the steering angle of one or more steered wheels of the motor vehicle. The steering shaft 1 is formed by a first shaft 2 and a second shaft 3, which is connected torque-induced with the shaft joint 4 with movable joints. The shaft joint 4 is held with the help of a device 6 for the pivotable mounting of the shaft joint 4 at a component 7, which is attached to the vehicle. The shaft joint 4 is formed as a homokinetic joint 8, consisting of an inner race 16 and an outer race in 11 with a spherical outer surface 12. Grooves for balls 17 are recessed in the outer race 11 and the inner race 16 on their mutually facing surfaces. As a result, swiveling of the outer race, 11 against the inner race 16 about both axes becomes possible, as does a constant transfer of torque over the balls 17 and grooves of the two races 11, 16. The device for the pivotable mounting of the shaft joint 4 at the component 7 attached to the vehicle makes possible a fixed position the steering shaft 1 at the component 7 attached to the vehicle and, moreover, a controlled swiveling of the steering shaft 1 in the driving direction or transversely to the driving direction, and also a swiveling into any other direction radial to the longitudinal axis 18 of the first and/or second shaft 2, 3 without causing noteworthy rotational nonuniformities during a rotational movement of the first and second shafts 2, 3.

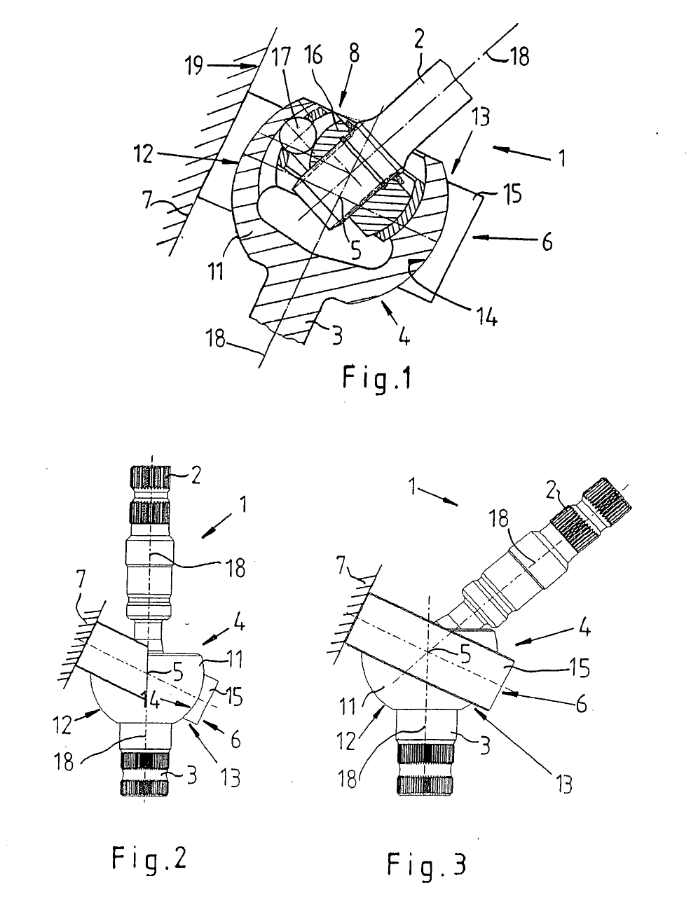

In the example of a steering shaft 1 shown in FIGS. 1 to 3, the device 6 for the pivotable mounting of the shaft joint 4 at the component 7 fastened to the vehicle is formed by a spherical plain bearing 13, constructed as a bearing ring 15 with a partially spherical inner surface 14, the inner surface 14 of the bearing ring 15 lying on the spherical outer surface of the after race 11, so that it can slide positively. The bearing ring 15 is fixed, positively or frictionally or directly without the intervention of another material at the component 7 that is attached to the vehicle. The annular shape of the bearing ring 15 makes a largely free swiveling of the first shaft 2 and of the second shaft 3 possible, the bearing ring 15 being placed about the outer race 11, so that the swiveling always takes place about the center 5 of the homokinetic joint 8. As a result, the steering shaft 1 or also the steering column belonging to the steering shaft can be shifted from a driving position into a position, in which the driver of the vehicle can enter or leave the vehicle, and back again in an exactly reproducible manner without rotational nonuniformities in the steering shaft 1 arising or even changing.

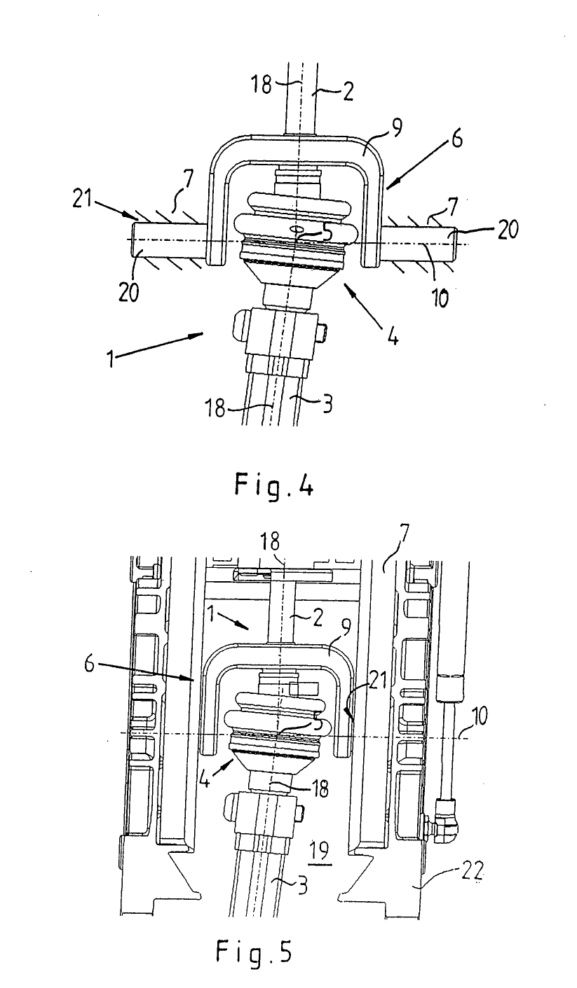

The perspective views of a steering shaft 1 in FIGS. 4 and 5 show an alternative embodiment of a device 6 for the pivotable mounting of a shaft joint 4 at the component 7, which is attached to the vehicle, the component 7, attached to the vehicle, being a fire wall 19 or a bearing block 22 of a commercial vehicle, the bearing block 19 being attached to the vehicle.

A swivel fork 9, through which the first shaft 2 protrudes, is constructed U-shaped or yoke-shaped and is held axially immovably but rotatably at the first shaft 2. A swing cone 20, which is mounted rotatably in a friction bearing 21 at the fire wall 19 and/or at the bearing block 22, which is attached to the vehicle, protrudes radially from the swivel fork 9 towards the first shaft 2 on each side. The swiveling axis 10, defined by the swing cone 20, passes through the center 5 of the shaft joint 4. Together with the friction bearing 21 or with the first shaft 2, the swivel fork 9 may form a cardan joint, which can swivel in all directions about the longitudinal axis 18 of the first or the second shaft 2, 3, so that all-around swiveling of the steering shaft 1 in reproducible positions is also possible with this device 6.

### LIST OF REFERENCE SYMBOLS

1 steering shaft.
2 first shaft.
3 second shaft.
4 shaft joint.
5 center of joint.
6 device.
7 component, attached to the vehicle.
8 homokinetic joint.
9 swivel fork.
10 swivel axis.
11 outer race
12 outer surface, spherical.
13 spherical plain bearing.
14 inner surface, spherical.
15 bearing ring.
16 inner race.
17 ball.
18 longitudinal axis of 2.3.
19 firewall.
20 swing cone
21 friction bearing.
22 bearing block

1.-15. (canceled)

16. A steering shaft assembly in a vehicle connecting a steering handling device with a steered wheel, comprising:
a first shaft;
a second shaft;
a shaft joint having movable joint parts connecting said first and second shafts in a torque-induced manner; and
a device providing pivotable mounting of said shaft joint to a component attached to the vehicle such that said movable joint can be swivelled approximately about a joint center thereof.

17. A steering shaft assembly according to claim 16, wherein the shaft joint is a homokinetic joint.

18. A steering shaft assembly according to claim 17, wherein the homokinetic joint is one of a simple and double joint.

19. A steering shaft assembly according to claim 16, wherein said device includes a swivel fork having a swiveling axis which passes approximately through the joint center.

20. A steering shaft assembly according to claim 19, wherein the swivel fork is disposed axially immovably at one of the first shaft and the second shaft.

21. A steering shaft assembly according to claim 19, wherein one of the first shaft and the second shaft is tiltably disposed in the swivel fork, independently of direction.

22. A steering shaft assembly according to claim 16, wherein said device includes an external ball race having a generally spherical outer surface which is disposed centrosymmetrically about the joint center, said ball race being mounted in a spherical plain bearing having an at least partially spherical inner surface.

23. A steering shaft assembly according to claim 22, wherein the spherical plain bearing includes a bearing ring.

24. A steering shaft assembly according to claim 16, wherein said device is fixed at a side wall of a driver cab of the vehicle.

25. A steering shaft assembly according to claim 16, wherein said device is fixed at one of a firewall and a bearing block of the vehicle, each which is attached to the vehicle.

26. A steering shaft assembly according to claim 16, wherein said device is fixed at an opening of a side wall of a driver cab of the vehicle.

27. A steering shaft assembly according to claim 16, wherein said steering shaft assembly is included as part or a commercial truck equipped with a tilting cab.

28. A steering shaft assembly according to claim 16, wherein said device is formed as including a plastic lubricant.

29. A steering shaft assembly according to claim 25, wherein said steering shaft assembly is part of an adjustable steering shaft arrangement which allows variation of a position of the steering shaft assembly, which includes a steering holding device, relative to the bearing block attached to the vehicle.

30. A steering shaft assembly according to claim 29, wherein a position of the steering shaft assembly in the vehicle is determined by devices which are different in construction from one another, and which fix a position of at least one of the steering shaft holding device and the steering shaft assembly.
